(19) United States
(12) Patent Application Publication
(10) Pub. No.: US 2026/0087509 A1
(43) Pub. Date: Mar. 26, 2026

(54) METHOD FOR SUBMITTING VIDEO PROOF OF THE STATE OF A TRADING CARD FOR REMOTE CERTIFICATION

(71) Applicants: Adrien MICHAUD, Paris (FR); Elise MICHAUD, Paris (FR)

(72) Inventors: Adrien MICHAUD, Paris (FR); Elise MICHAUD, Paris (FR)

(21) Appl. No.: 19/110,349

(22) PCT Filed: Sep. 11, 2023
(86) PCT No.: PCT/FR2023/000145

§ 371 Date: Mar. 10, 2025

(30) Foreign Application Priority Data
Sep. 13, 2022 (FR) FR2209148

(51) Int. Cl. G06Q 30/018; H04N 23/60

(52) U.S. Cl. CPC G06Q 30/0185; H04N 23/64

(57) ABSTRACT

This invention relates to a method allowing collectors to submit a video proof of the condition of their collection cards to obtain remote certification by a competent third party of the condition of their filmed cards.

The process mainly involves the following steps:
E1—Recording by a user device of a video capturing the following steps performed by said user:
   E1.1—Presentation of the card
   E1.2—Insertion into the protection device
   E1.3—Closure and sealing of the protection device
   E1.4—Presentation of the different sides of the sealed protection device
   E1.5—Presentation of the unique identifier of the protection device
   E2—Automatic transfer by said user device connected to a remote network of said video to a remote storage server accessible to the competent third party.

### RELATED APPLICATION

This application claims priority, under applicable law, to French provisional patent application No. FR2209148, filed on Sep. 13, 2022, and entitled “Method for Remote Verification of the Condition of a Collectible Card and Its Sealing in a Protective Case, and Device for Displaying and Protecting the Collectible Card,” which is incorporated herein by reference in its entirety for all useful purposes.

### FIELD OF THE INVENTION

The field of the invention relates to the certification of the condition and/or authenticity of collectible or trading cards, such as sports cards or trading game cards. More specifically, the invention pertains to a method allowing a collector to send a video to a qualified professional, such as a grading company (as defined below), which can use it to remotely certify the condition and/or authenticity of the collector's card.

### PRIOR ART

Collecting cards is an activity that blends passion and investment. The passion often begins in schoolyards, where children trade Pokémon® cards, Magic: The Gathering® cards, and other collectible or trading game cards (hereinafter referred to as “cards”). The investment aspect emerges when, as teenagers and then adults, they become aware of the value of their collection and the effort required to acquire the rarest cards.

At this stage, collectors start paying increasing attention to the condition of their cards. Indeed, any damage or defect in a card directly impacts its value.

Thus, accurately assessing the condition of a collectible card is essential for determining its value. This is the role of “grading companies” or “classification companies.” These are neutral professionals responsible for:
Verifying the authenticity of a card,
Assessing its defects based on a reference scale to assign it a grade,
Encapsulating it in a hermetically sealed transparent protective case.

In the context of this invention, collectible cards that have been authenticated, graded, and encapsulated by a grading company will be referred to as “graded cards” or “certified cards.” The term “encapsulation” refers to the placement of the collectible card into a specially designed protective case, its closure, and its simultaneous sealing.

If a card is not in exceptional condition, the collector may also request that the grading company only certify its authenticity before encapsulating it.

The grade assigned to the card, typically on a scale of 1 to 10, is recorded on a label that is encapsulated alongside the card.

The grade may also be accompanied by an explanatory designation:“a grade”. For instance, based on the grading scale defined by the professional, a score of 10 may be associated with designations such as “Perfect Condition,” “GEM MINT,” or “PRISTINE,” which are universally recognized terms in the grading industry to describe a flawless card.

The protective case serves as a guarantee that the card's condition will remain unchanged over time. It is permanently sealed, meaning that removing the card requires irreversibly damaging the case. The case has a compartment specifically designed to hold the card securely, as well as another compartment to hold the grading label.

The grading label, in addition to displaying the card's grade and/or condition designation, may contain various details such as: The name of the certifying organization, its logo, the card's identity, a unique identifier.

The unique identifier is crucial for distinguishing graded cards that share the same artwork. Each certified card has its own unique identifier, usually a unique serial number. This identifier allows collectors to retrieve the card's certification details on the grading company's website to verify its authenticity.

To seal the case, the grading company preferably uses an ultrasonic welding machine. This welding method, known to be the most effective, requires specialized, bulky, and non-portable equipment.

For this reason, the grading process (hereinafter also referred to interchangeably as the “certification process”), which includes the authentication, evaluation, and encapsulation of the card, must necessarily be carried out in a workshop, making it essential for collectors to send or drop off their cards at the grading company.

However, since collectible cards are fragile objects, even the slightest handling can damage them and reduce their value. Many collectors are reluctant to entrust their cards to postal services or even to a grading company to avoid any risk of loss or damage.

While grading companies may offer financial compensation in the event of damage or loss, they can never fully repair the harm suffered by the collector, who may have an irreplaceable sentimental attachment to a damaged or lost collectible card.

Additionally, sending a high-value card to a grading company also involves significant shipping, insurance, and customs fees, both for outgoing and return shipments.

The challenge, therefore, is to develop a method that enables remote grading while maintaining the same level of control as traditional in-house grading. The third-party certifier must be able to verify the card's condition and ensure its correct placement inside a properly sealed protective case, a process that is fully controlled when grading is performed in-house.

In the context of this invention, the terms remote grading or remote certification refer to a process in which the collector no longer needs to send their card to a grading company. Instead, the grading company, through the implementation of the method described in this invention, can remotely assess the card's condition and verify its encapsulation in a suitable protective case that is manually sealed by the collector.

### Technical Challenges

Implementing a remote grading system that is as reliable as in-house grading is a significant challenge that no company has yet achieved.

The main difficulty lies in the grading company's inability to guarantee the future condition of a card that it has not personally encapsulated in a specialized protective case. In other words, while the company may be able to assess a card's condition remotely, for example, by analyzing photos or a scan of the card, it cannot ensure that the card will remain in the same condition after this evaluation.

The third-party certifier's mission requires that it be able to verify both the card's condition and its proper placement within a sealed protective case.

Developing a method that meets these strict control standards while allowing the process to be conducted remotely is highly complex. This is the objective of the present invention, which offers a unique solution to this technical problem.

### SUMMARY OF THE INVENTION

The invention described herein addresses the technical challenges mentioned above by introducing a method that meets the necessary control standards as previously explained. This method enables a grading company to remotely evaluate the condition of a collectible card and ensure its preservation, without ever having to physically take possession of it.

More specifically, the invention introduces a novel and inventive method consisting of a submission process carried out by a collector (hereinafter interchangeably referred to as “collector user” or “user”) to provide video proof of the condition and/or authenticity of their card and its encapsulation. This video is automatically transferred to a remote storage server, allowing a qualified third party (hereinafter interchangeably referred to as “third party,” “third-party certifier,” or “qualified third party”), such as a grading company, to certify the condition and/or authenticity of the card.

### Technical Solutions

The method described for submitting video proof relies on the following components:

1° A user device capable of connecting to a remote network, equipped with a digital camera and a human-machine interface. This device also includes dedicated software that allows the user to record the video and export it to a remote storage server.

2° A protective device specifically designed for implementing this invention, characterized by two main attributes: A sealing and locking element (explained below), and a unique identifier (also explained below).

The protective device refers to a transparent plastic case intended to hold, protect, and display a collectible card.

The sealing and locking element is a security component integrated into the protective device, designed to ensure the integrity of the closure. Its main functions are: Allowing the collector to manually and permanently close the case, and ensuring that any attempt to reopen the protective device results in an irreversible alteration, making any unauthorized access immediately apparent. More precisely, this element can take several forms:
clips designed to deteriorate permanently if the protective device is reopened;
an adhesive or adhesive label that leaves residual marks or causes discoloration in the event of reopening;
an interlocking mechanism calibrated to work in synergy with intentionally weakened areas of the device. Upon reopening, these fragile areas will visibly degrade.

The unique identifier can take various forms, including a combination of numbers and/or letters, a QR code, or a barcode. It can be engraved on the surface of the protective device, integrated into its structure, or displayed on an adhesive label affixed to it. The unique identifier serves not only to guarantee the authenticity of the certified object by making it easily identifiable and traceable, but also to streamline the certification process for the third-party certifier. The certifier can issue a certificate explicitly referencing this unique identifier to confirm the condition and/or authenticity of the collectible card.

It should be noted that, to date, no existing protective device on the market is specifically designed to implement this invention.

The method described in this invention is characterized by the following main steps:
E1: The user device records a video capturing the following steps performed by the user:
E1.1: A complete and detailed presentation of the collectible card, following the instructions provided in a user manual that comes with the protective devices. In the most common procedure, the user must present both sides of the card from different angles under a light source, ensuring that it reveal all defects, including stains, dents, scratches, creases, image misalignment, color fading, cutting or printing defects, etc.;
E1.2: Placement of the collectible card into the previously described protective device;
E1.3: Manual closing and sealing of the protective device containing the card (further explained below);
E1.4: Presentation of all sides of the sealed protective device to allow the third-party certifier to verify that it has been properly closed and sealed, following the instructions provided in the user manual;
E1.5: Presentation of the unique identifier of the protective device so that it can be recorded by the third-party certifier.

The unique identifier can also be detected automatically by the user device, provided it is equipped with an appropriate recognition system, such as: a QR code scanner, an NFC chip reader, or an optical Character Recognition (OCR) software.

The recording of these steps is performed continuously and without interruption, ensuring that the third-party certifier can verify that the card has not been damaged or replaced between the moment it was initially presented and its placement into the sealed protective device, as captured in the video.
E2: Automatic transfer of the video from the user device, which is connected to a remote network, to a remote storage server.

The video file name includes the user's email address and a timestamp indicating the date of video creation. This ensures easy identification of the user receiving the certification, as their email and mailing address were previously provided, particularly during the acquisition of the protective devices.

In the event of a temporary network connection failure, the video file is temporarily stored in a dedicated memory on the user device, which remains inaccessible to the user until the connection is restored, at which point the video transfer is initiated. It is imperative that the user cannot modify the video file before submission to prevent any attempt at fraud.

The Method Also Includes the Following Additional Steps:
a request for user identification by the user device, which associates the user with their personal space on the remote storage server. The user's identification data is then linked to the video file, enabling the third-party certifier to know who to issue the certification to. The user device is also designed to collect the user's current address via a form, allowing for address updates in case it has changed since the acquisition of the protective devices.
an initiation of the video recording via a human-machine interface on the user device, triggered by the user through a start command.
stopping the video recording via the human-machine interface on the user device, triggered by the user through a stop command.
receiving a notification or confirmation message verifying the successful transfer of the video, or receiving a failure message indicating an unsuccessful transfer.
reattempting the transfer in the event of a failed transmission.
sending a notification to the third-party certifier, informing them that a certification request is ready for processing.

The method is also characterized by pre-recording preparations carried out by the user, including:
placing the collectible card (whose condition and/or authenticity is to be assessed) within easy reach, along with the previously acquired protective device.
adjusting the lighting, preferably using a spotlight with a minimum output of 1000 lumens (a unit measuring light flux), with a Color Rendering Index (CRI) of at least 90. The CRI quantifies how accurately a light source reproduces colors compared to an ideal light source. The light source should be positioned within 50 centimeters of the recording area, directed toward the card. Proper lighting is essential for capturing the card's finest details, ensuring an accurate representation of its colors, textures, and overall condition, thus allowing for a more precise assessment of its authenticity and state of preservation.
stabilizing the user device, preferably using a tripod, to ensure optimal video quality. The use of a tripod securely holds the device in place, minimizing vibrations and unintended movements that could compromise image sharpness.

### BRIEF DESCRIPTION OF THE FIGURES

Additional objectives, features, and advantages of the invention will become more apparent upon reading the following description, which is provided as a non-limiting illustrative example, in relation to the following figures:

FIG. 1 presents a functional diagram of the method according to the invention.

FIG. 2 is a diagram illustrating the environment in which the method is implemented.

FIG. 3 is a diagram illustrating the main characteristics of a protective device in accordance with the present invention.

FIG. 4, FIG. 5, FIG. 6, and FIG. 7 are diagrams depicting the main steps of the method according to the invention.

### DETAILED DESCRIPTION

The general principle of the invention allows for the implementation of a remote certification system for the condition and/or authenticity of collectible cards.

In particular, the method of the invention enables a collector to send video proof to a remote storage server via a user device. This video provides a detailed presentation of a collectible card as well as its encapsulation in a sealed protective device with a unique identifier.

As a result, a qualified third party, such as a grading company, accessing this video proof will be able to carefully analyze the card, verify its authenticity, and/or assess its condition in order to certify it.

By showing the encapsulation of the card immediately after its presentation in a sealed protective device, the video ensures the continuous integrity of the certification, guaranteeing that the card remains in the certified state.

The presence of a distinct unique identifier on the protective device confirms that the certification applies exclusively to that specific card.

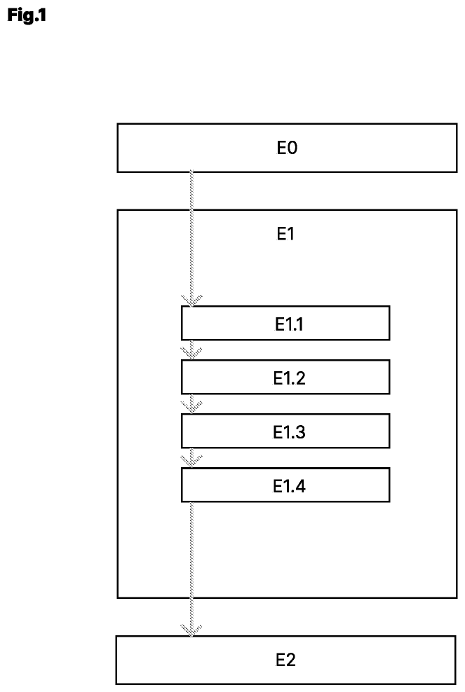

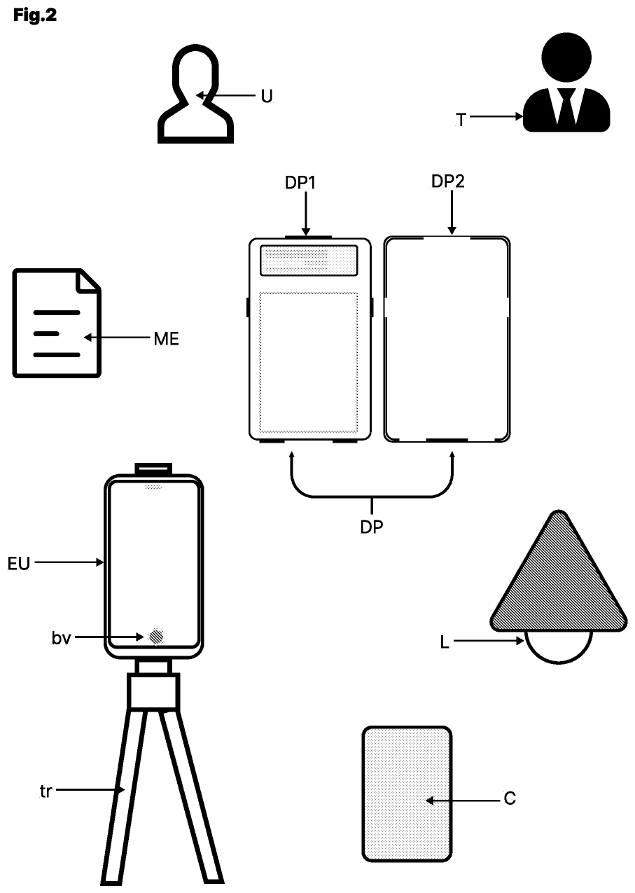

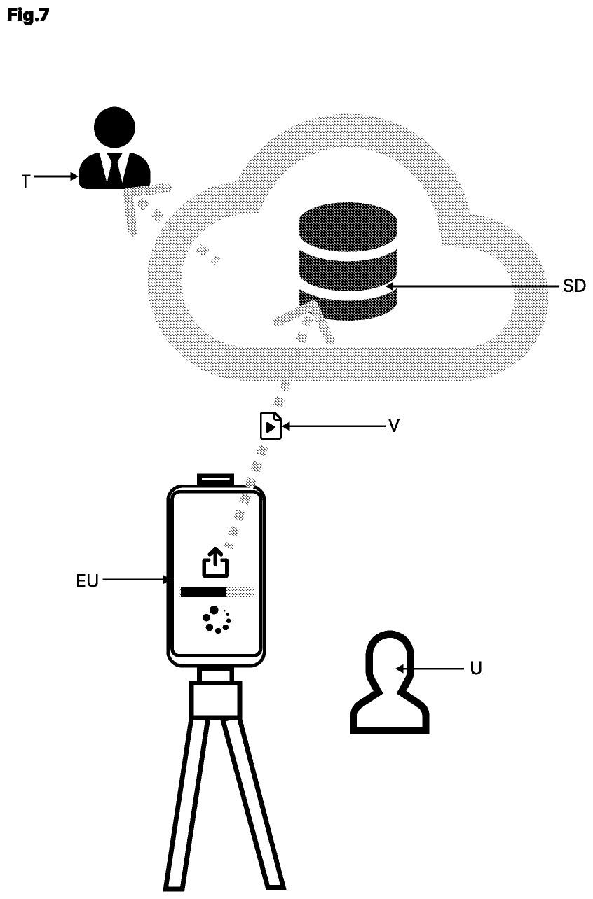

The following steps outline the submission process, as illustrated in FIG. 1, according to an implementation of the invention:
E0: A preparation step, which is the subject of a subsidiary claim, linked to FIG. 2;
E1: The creation of video proof, linked to FIG. 4 to FIG. 6, which is part of the main claim;
E2: The transfer of video proof to a remote storage server, linked to FIG. 7, also part of the main claim.

FIG. 2 illustrates the environment necessary for implementing step E0, which is the subject of a subsidiary claim:

E0: Prior to implementing the submission process according to the invention, in step E0, the collector user (U) purchases protection devices (PD) from a specialized professional, generally the competent third party (T), for example, through their website. On this occasion, the user receives an instruction manual (IM), for example, in the form of a printed booklet, outlining the different steps of the submission process as indicated below.

It should be noted that the collector user (U) must strictly follow the specific instructions of the instruction manual (IM) to obtain the desired certification.

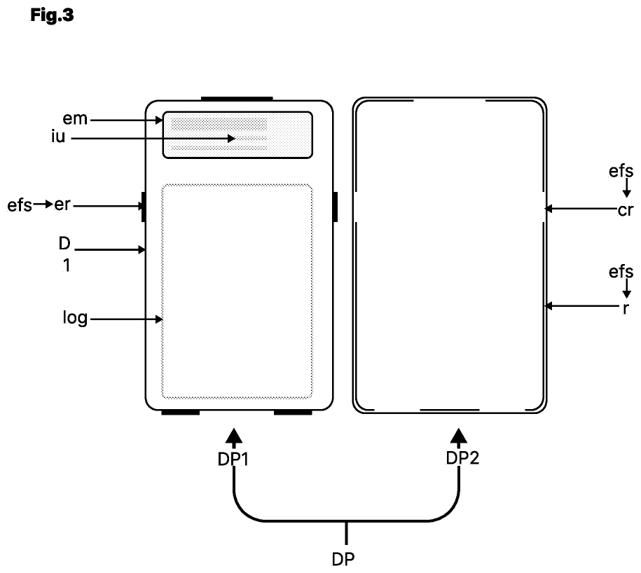

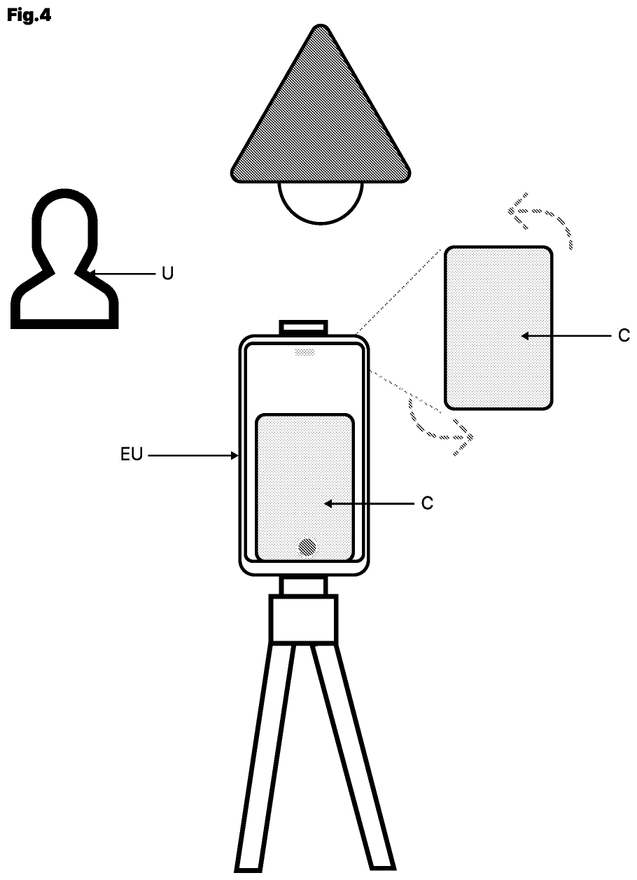

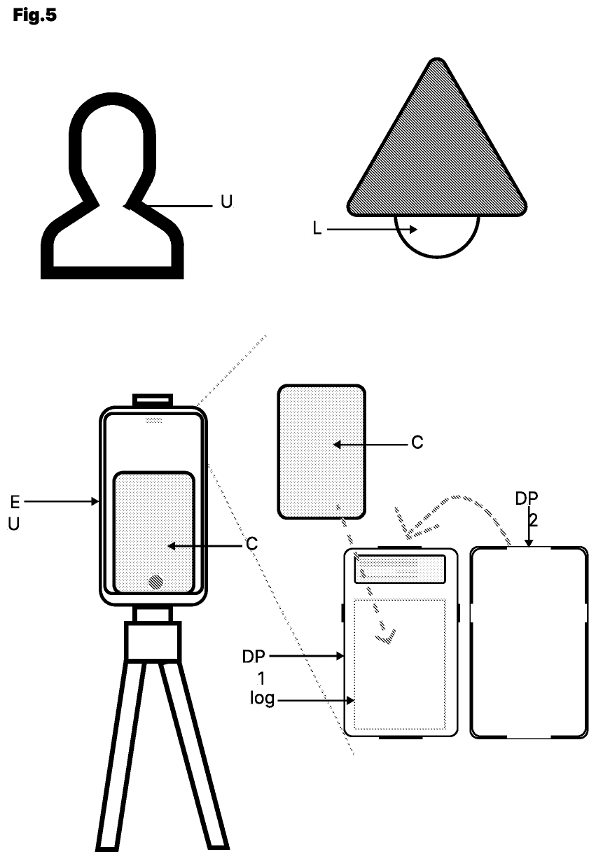

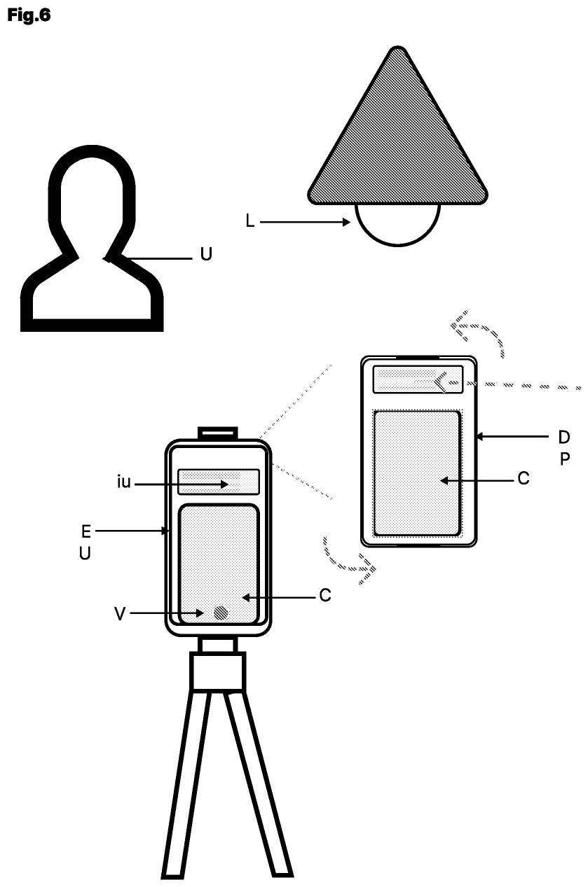

A protection device (PD) according to the invention is briefly presented in FIG. 2 and more fully detailed in FIG. 3.

FIG. 3 shows an embodiment of a protection device (PD) unused and in compliance with the present invention.

It consists of two interlocking parts: a first part forms a base (PD1) and includes a housing designed to receive and secure a card (not shown here); a second part forms a cover (PD2) that fits onto the base (PD1) to permanently close the protection device (PD).

The base (PD1) contains a molded label (ml) created through an overmolding process during the injection molding of the case, as well as a housing space (hs) designed to receive and secure the card (C) to be certified. The molded label (ml) is a printed plate integrated into the base (PD1) during the injection molding process, containing information for traceability (the unique identifier (ui)) and/or the identification of the card (C) to be certified.

The cover (PD2) consists of an edge (e) that fits into the base (PD1). The edge (e) is grooved to accommodate the lugs (l) protruding from the base (PD1). In this embodiment, these edges (e), lugs (l), and grooves (g) are designed to allow the protection device (PD) to be manually and permanently closed by the user (U). They form the closure and sealing element (cse) of the protection device.

The closure and sealing element (cse) is a security component integrated into the protection device (PD), designed to ensure the integrity of the closure. Its primary functions are to allow the user to manually and permanently close the protection device and to ensure that any attempt to reopen the protection device (PD) results in an irreversible alteration, making any unauthorized access evident.

More specifically, this element can take several forms:
Clips designed to break or visibly and permanently deteriorate in case of reopening the protection device;
An adhesive, or an adhesive label, that leaves residual marks or causes discoloration if the device is reopened;
A calibrated interlocking mechanism designed to work in synergy with intentionally weakened areas of the protection device (PD). Upon reopening the device, these fragile areas visibly and irreversibly deteriorate.

The protection device (PD) also includes a unique identifier (ui) that is easily recognizable, such as a serial number, a QR code, an NFC chip, a barcode, or any other type of unique identifier serving the same function. The unique identifier (ui) can be engraved or printed directly on the protection device (PD), embedded within it, or displayed on an adhesive label affixed to the protection device (PD).

The unique identifier (ui), different on each protection device (PD), allows them to be distinguished from one another. It also enables the competent third party (T) to issue its certification for a unique card, identified by the unique identifier (ui) present on the protection device (PD).

In a preferred embodiment shown in connection with FIG. 3, the unique identifier (ui) is printed on the molded label (ml) and rendered inaccessible once the case is molded around it, ensuring protection against any tampering.

In another embodiment, the unique identifier is displayed on a label with an electronic display screen, such as “E-paper®” or “E-ink®,” integrated into the protection device and equipped with an NFC chip. The advantage of this embodiment is the ability to remotely control the label display to show the certification of the competent third party or information related to the identity of the certified card.

Additionally, it is recommended that the protection device (PD) bear a mark or engraving representing the logo or name of the company selling it, ensuring the use of a protection device (PD) that meets the aforementioned characteristics (i.e., the presence of a unique identifier (ui) and a closure and sealing element (cse)).

Regarding the general characteristics of the protection device (PD), it is preferably a rigid case made of transparent plastic material, such as polymethyl methacrylate or polycarbonate, with a size adjusted to fit the card to be protected (C).

It generally consists of two interlocking parts: the first part forms the base (PD1) and features a housing designed to receive and secure the card (C); the second part forms the cover (PD2).

The collector user (U) must also have a user device (UD) capable of connecting to a remote network, including a human-machine interface and a camera. This user device (UD) could be a smartphone, a tablet, or a computer. To be able to send a video proof to the certifying third party (T), the user (U) must first install dedicated software (or hereinafter referred to interchangeably as “computer application” or “application”) on this device (UD) that allows the recording of the video and its transfer to a remote storage server (RSS).

Preferably, the user (U) will use their smartphone equipped with a mobile application compatible with iOS and Android operating systems, allowing them to create and submit a video of their collection card (C) for the submission process according to the invention.

Specifically, this application allows:
1. The collector user (U) to log into a personal session using a personal identifier and optionally a password, ensuring that the recorded video is associated with their user account, containing their basic personal information: name, first name, address, and email. The user (U) must also accept the application's terms and conditions before being able to use it.
2. The collector user (U) to start recording a video from the interface of the user device (UD). The video resolution is determined by the application to prevent the user (U) from selecting an insufficient quality. It is essential that the certifying third party (T) can clearly see all the defects of the presented card (C), which requires that the video (V) meets a certain minimum quality standard, predefined by the competent third party (T).
3. The export (or interchangeably “transfer”) of the video to remote storage servers (RSS) without allowing the user (U) to modify it, thereby assuring the certifying third party (T) that the video has not been altered.

The term “remote storage server” (RSS) refers to a server located outside the user's local environment. Specifically, this could be a “cloud” storage server or the storage server of the grading company.

Optionally, the dedicated application installed on the user device (UD) may also include the following features, which are not essential but are useful for enhancing the user (U) experience and improving the accuracy of the certification:
A graphical interface allowing the collector user (U) to view the video upload in real time and confirm its successful export to the remote storage server (RSS). In case of transfer interruption, the user (U) can restart the export. Once the video is exported, the user (U) can, if desired, download a copy of the video to the media library of their user device (UD) for later viewing;
A visual guidance module providing visual aids overlaid on the screen during filming, such as guidelines, animated arrows, or a framing box, thereby facilitating optimal positioning and presentation of the collection card (C);

The term “module”refers to any software system.
A guidance module incorporating written or oral instructions, detailing the steps to correctly position the collection card (C) on the screen;
A brightness analysis module that evaluates the lighting quality of the scene, automatically adjusts the image brightness if necessary, and ensures that the card (C) is sufficiently lit to highlight all its defects;
A card (C) detection module capable of identifying its position on the screen and providing guidance to optimize its positioning;
An automatic defect detection module that uses advanced mathematical algorithms to detect and highlight imperfections on the card (C);
A real-time grading module based on artificial intelligence, which analyzes the video images and assigns a grade to the collection card (C) according to predefined criteria;
A network connection verification module (e.g., Internet), essential for sending the video to the remote storage server (RSS);

Following this step E0, illustrated in FIG. 1, the collector user (U) prepares their environment to record the video in accordance with the procedure described below (see E1). This preparation involves the following preliminary actions by the user (U):
1—Place within reach the collection card (C), whose condition and/or authenticity is to be certified, as well as the previously mentioned protection device (PD) (see E0).

The protection device (PD), opened and new, must be ready to accommodate the card (C);
2—Ensure adequate lighting, preferably a spotlight (L) with a minimum power of 1000 lumens and a Color Rendering Index (CRI) of at least 90, positioned less than fifty centimeters from the filming scene and directed towards the card to be presented. To guarantee a faithful reproduction of the card's colors, it is recommended to use a light (L) with a neutral color temperature;
3—Stabilize the user device (UD), preferably using a tripod (tr), to ensure optimal video quality. Ideally, using a tripod (tr) helps securely fix the user device (UD), thereby minimizing vibrations and unintentional movements that could compromise the sharpness and accuracy of the recorded image;
4—Launch the dedicated application on the user device (UD) for video recording, log into their session to access the application's content, and display the button (bv) on the screen to trigger the video recording.
E1: Following step El, illustrated by FIG. 4 to FIG. 6, the collector user (U) starts the video recording using the dedicated application installed on the user device (UD) and follows the steps below, ensuring the card (C) remains within the camera's field of view at all times:
E1.1: As shown in FIG. 4, the user presents the collection card (C) to the camera from all angles, following the instructions provided in the manual and any oral or written indications displayed on the screen. Preferably, the card (C) is positioned at an average distance of twenty centimeters from the camera, as close as possible while maintaining a sharp image. The collector user (U) shows the entire surface of the card (C), both front and back, under the various inclinations indicated in the manual, to reveal any surface defects, moving it slowly. This process should last between 30 seconds and 2 minutes, depending on the given instructions;
E1.2: Once the card (C) has been presented, as shown in FIG. 5, the user (U) “gently” places it into the designated slot of the protection device (PD).

In this context, “gently” refers to how the user (U) handles the collection card (C) with care and caution, avoiding any abrupt or negligent actions that could damage or alter the card (C) when placing it in the protection device (PD).
E1.3: Still referring to FIG. 5, the user (U) closes and seals the protection device (PD);
E1.4: As shown in FIG. 6, the user then shows the camera of the user device (UD) that the protection device (PD) is “properly” closed and sealed, presenting it at less than 30 centimeters from the lens, from all angles.

In this context, “properly” indicates that the protection device (PD) is closed and sealed according to the instructions provided in the manual.
E1.5: Finally, still referring to FIG. 6, the collector user (U) presents the unique identifier (ui) of the protection device (PD) to the camera of the user device (UD), so that the competent third party (T) can record it. In another embodiment, the unique identifier (ui) may also be automatically detected by the application, provided it is equipped with an appropriate recognition system. Preferably, the unique identifier (ui) consists of a sequence of numbers and/or letters. Example: C000001.

In one embodiment, the user (U) repeats this step (E1) for each card whose condition and/or authenticity they wish to certify in a single video.

In another embodiment, and preferably, the collector user (U) creates one video per sealed card (C) to reduce the risks associated with large file transfer issues.

E2: Following step E2, illustrated by FIG. 7, the user (U) completes the recording, triggering an automatic transfer of the video (V) to a remote storage server (RSS). button

In one embodiment, the user device (UD) transfers or exports the video (V) upon stopping the recording. For example, when the user (U) presses a stop recording button on the graphical interface of the application. It is the action of stopping the recording that initiates the transfer of the video (V) to the remote storage server (RSS).

In another embodiment, the video (V) export can be performed continuously during recording through a real-time video streaming system.

Once these three steps E0, E1, and E2 are completed, the video is made available to the competent third party (T), such as a grading company.

Although the invention described in this patent application is limited to steps E0 to E2 establishing the fundamental process enabling the competent third party (T) to issue its certification, it is nonetheless useful to describe the steps that generally follow to achieve certification by a grading company acting as the competent third party (T):

1° Once the video (V) is made available on a remote storage server (RSS) accessible to the competent third party (T), it can be reviewed to verify compliance with the procedure (step E1) and to analyze the condition of the card (C) and/or its authenticity.

The method for evaluating the condition of a collection card varies depending on the professional.

One method involves identifying all the defects of the card to determine its correspondence on a pre-established grading scale and assign a grade and/or rating.

For example, if the card (C) is in perfect condition with no apparent defects, it may receive a score of 10/10, often associated with the GEM MINT grade, indicating that the card (C) is visually in perfect preservation condition.

The competent third party (T) may also assign the “Authentic” grade instead of a score if the collector user (U) only wishes the third party (T) to verify the authenticity of the card (C) without grading its condition.

2° Once the grade and/or rating is assigned, the competent third party (T) enters the certification data into a database, generally including: the name of the card (C), its photo, its information such as its language, the collection to which it belongs, its rarity; the obtained grade and/or rating; the list of any potential defects of the card (C); the unique identifier (ui) of the protection device (PD); the certification date

3° This information allows the professional to make available on their website a certificate in the form of a dedicated web page summarizing the data related to the certified card (C), accessible to everyone.

4° The professional may also issue a sticker to be affixed to the protection device (PD), displaying the following information: the unique identifier (ui) of the protection device (PD), the grade and/or rating, and the logo of the third-party company (T). This sticker may also be equipped with an NFC chip, allowing the certified card (C) holder to access the online certificate when scanned by a smartphone.

### Variants in the Process

A proposed variant of the video proof submission process allows the user (U) to create their video (V) using any mobile application capable of producing an original exportable video file, without automatic export at the end of the recording. In this variant, after recording the video, the user (U) manually transfers the video file to a remote storage server (RSS) through a secure large file transfer system provided by the competent third party (T), such as “Wetransfer®.”

Once the video file (V) is received on the remote storage server (RSS), specially designed software is deployed to analyze the video file (V). This software checks the integrity of the video file (V), ensuring it has not been corrupted during transfer or modified in any way after recording. If the software confirms that the video file (V) is original and intact, it is then made available to the competent third party (T) for viewing.

According to another proposed variant, the export of the video (V) can be performed continuously during recording through a real-time video streaming system, always to prevent the user (U) from modifying the file.

Another proposed variant is to replace the video (V) with a three-dimensional capture, for example, consisting of a set of distance data between a user device (UD) and the collection card (C) obtained by a distance sensor. The advantage of this variant is the ability to detect abnormal indentations or reliefs on the card (C), such as a bump or a deposit of material.

### Alternative Mode of Implementation

The presented invention can also be industrially utilized by online sales platforms, such as “eBay®,” and live sales platforms (in French: live streaming sales where a seller presents their products for sale), such as “Whatnot®” or “VOGGT®,” for trading collection cards. The process allows sellers of collection cards to provide irrefutable proof of the condition of their cards and their secure packaging in a sealed and uniquely identified protection before shipment. This effectively addresses common buyer concerns about fraud risks. Through this system, a video proof ensures that the shipped card, contained in a specifically identified protection device, is exactly the same as the one received by the buyer. This method significantly reduces common frauds where a seller presents a card in good condition for sale but sends a similar card in inferior condition, thereby offering increased security for the buyer. This type of fraud, difficult to detect, complicates refund requests made through online sales platforms. The adoption of this process by sales platforms would reduce the number of disputes to resolve and increase user confidence.

### Implementation

For online sales platforms, they could require users to use this process to obtain a link provided by the competent third party that will redirect the potential buyer to the video stored on the remote storage server. This link could appear on the sales listing, providing reassurance to the potential buyer, who can freely view the video to observe the condition of the collection card and verify its placement in a sealed and uniquely identified protection device.

For live sales platforms, sellers could use the process during a live broadcast by following the above steps to enhance the confidence of potential buyers connected to the live stream.

1. A method for submitting to a third party (T) a video proof (V) of a condition and/or authenticity of a collection card (C) of a user (U) for remote certification of said condition and/or authenticity of said card (C) by said third party (T), said method being characterized in that it comprises the following steps:
E1—A recording by a user device (UD) capable of connecting to a remote network, on which is installed dedicated software for creating a video and transferring it to a remote storage server, equipped with a digital camera and a human-machine interface, of a video (V) capturing the following steps performed by said user (U):
E1.1—A complete, detailed presentation framed with the help of a user manual, of all the surfaces of said collection card (C);
E1.2—Placement of said collection card (C) in a protection device (PD) marked with a unique identifier (ui) and including a manual closure and sealing element (cse);
E1.3—Manual closure and sealing of said protection device (PD) containing said card (C);
E1.4—Presentation of all surfaces of said closed and sealed protection device (PD);
E1.5—Presentation of the unique identifier (ui) of said protection device (PD);
E2—Automatic transfer by said user device (UD) connected to a remote network of said video (V) to a remote storage server (RSS).

2. The method according to claim 1, characterized in that the recording of steps E1.1 to E1.5 is performed continuously and without interruption.

3. The method according to claim 1, characterized in that it further comprises:
A request by said user device (UD) for the user's (U) identifiers to associate them with their personal space on the remote storage server (RSS);
A start of said recording from a human-machine graphical interface of said user device (UD);
A stop of said recording from said human-machine graphical interface of said user device (UD);
A reception from said human-machine graphical interface of said user device (UD) of a notification or a verification message of a successful transfer of said video or a reception of a failed transfer message;
A restart of said transfer in case of receipt of said failed transfer message;
A transmission to the certifying third party (T) of a warning message that a certification request is to be processed.

4. The method according to claim 1, characterized in that said video file (V) includes in its title the email address of said user (U) and the timestamp of the creation date of said video (V).

5. The method according to claim 1, characterized in that said closure and sealing element (cse) is a security component integrated into said protection device (PD), designed to allow the user to close it permanently and ensure the integrity of said closure by guaranteeing that any attempt to reopen said protection device (PD) results in an irreversible alteration, thus making any unauthorized access evident, chosen from among:
One or more clips, designed to visibly and permanently deteriorate in case of reopening said protection device (PD);
An adhesive and/or at least one adhesive label, which leaves residual marks or causes discoloration in case of reopening said protection device (PD);
A calibrated interlocking mechanism designed to work in synergy with one or more intentionally weakened areas of said protection device (PD) that break and/or deform irreversibly in the event of reopening said device.

6. The method according to claim 1, characterized in that the unique identifier (ui) of said protection device (PD) is engraved directly on and/or within said protection device (PD), and/or appears on an adhesive label affixed to said protection device (PD).

7. The method according to claim 1, characterized in that it further includes, prior to the recording of said video (V), the following preparatory measures implemented by said user (U):
a—Placing within the immediate reach of said user (U) the collection card (C) whose condition and/or authenticity is to be evaluated, as well as the protection device (PD),
b—Adjusting a lighting system, preferably a spotlight (L) with an intensity of at least 1000 lumens and a Color Rendering Index (CRI) of at least 90, positioned at a distance not exceeding fifty centimeters from a shooting area, and specifically directed towards said card (C) to be evaluated.
c—Stabilizing said user device (UD) using a tripod (tr).
d—Familiarizing oneself with said user manual, detailing precisely the steps to follow.
